(19) United States
(12) Patent Application Publication
(10) Pub. No.: US 2010/0109545 A1
(43) Pub. Date: May 6, 2010

(54) Automatic Compensation For Degradation Of Optocoupler Light Emitting Diode

(75) Inventors: Chad D. Eiring, Delaware, OH (US); Daniel M. Chrystal, Marengo, OH (US); Mark K. Valesky, Westerville, OH (US); Stephen E. Crump, Prospect, OH (US)

Correspondence Address: HARNESS, DICKEY & PIERCE, P.L.C., P.O. BOX 828, BLOOMFIELD HILLS, MI, 48303, US

(73) Assignee: Liebert Corporation, Columbus, OH (US)

(21) Appl. No.: 12/574,797

(22) Filed: Oct. 7, 2009

Related U.S. Application Data
(60) Provisional application No. 61/111,062, filed on Nov. 4, 2008.

(51) Int. Cl. H05B 41/16; H05B 39/04

(52) U.S. Cl. 315/246; 315/291

(57) ABSTRACT

A system and method for compensating for degradation of a light emitting diode includes accumulating time that the light emitting has been lit. An additional amount of drive current to be provided to the light emitting diode is determined based on the accumulated time that the light emitting diode has been lit. The system includes a controller that accumulates the time that the light emitting diode has been lit and determines the amount of addition drive current to be provided to the light emitting diode.

### CROSS-REFERENCE TO RELATED APPLICATIONS

This application claims the benefit of U.S. Provisional Application No. 61/111,062, filed on Nov. 4, 2008. The entire disclosure of the above application is incorporated herein by reference.

### FIELD

The present disclosure relates to optocouplers.

### BACKGROUND

This section provides background information related to the present disclosure which is not necessarily prior art.

In electronics, an optocoupler is a device that uses a short optical transmission path to transfer a signal between elements of a circuit, typically a transmitter and a receiver, while keeping them electrically isolated. Typically, an electrical signal is transformed to an optical signal before being transmitted through the transmission path. The transmitted optical signal is then transformed back to an electrical signal. In this way, electrical contact along the path is broken.

Referring now to FIG. 1, a simplified schematic of a typical optocoupler 100 is presented. The optocoupler 100 has a transmitting element, such as a Light Emitting Diode (LED) 105, and a receiving element, such as a phototransistor 106. The LED 105 and the phototransistor 106 are separated so that light may travel across a barrier but electrical current may not. When an electrical signal is applied to an input 101 of the optocoupler, which is coupled to an anode of the LED 105, the LED 105 lights. Light from the LED 105 then activates the phototransistor 106, which in turn generates a corresponding electrical signal. The output current from the phototransistor 106 is typically proportional to the amount of incident light supplied by the LED 105.

The optical path between LED 105 and phototransistor 106 can be air or a dielectric waveguide. LED 105 and phototransistor 106 can be contained within a single compact module, for mounting, for example, on a circuit board.

When using optocouplers to isolate a system with high frequency signals, propagation delay across the optocoupler is directly related to the maximum frequency of the signals that can be reliably transmitted across the optocoupler. A LED as a light source degrades (that is, its light output decreases) over time, mainly based on the total time that it has been lit. LED's of optocouplers are typically driven with a fixed amount of drive current. Consequently, as the LED of an optocoupler degrades, the propagation delay across the optocoupler increases. An increased propagation delay can reduce the maximum communication speed of a system employing an optocoupler. To compensate for this degradation, the systems are over designed, or the maximum communication speed of the system is reduced. Over designed in this context is setting the fixed LED drive current higher than required for correct operation during the early life of the optocoupler to compensate for the higher current required to drive the LED of the optocoupler later in the life of the optocoupler due to the degradation of the LED over time.

### SUMMARY

This section provides a general summary of the disclosure, and is not a comprehensive disclosure of its full scope or all of its features.

A system for compensating for degradation of a light emitting diode of an optocoupler includes a controller that accumulates time that the light emitting diode has been lit. The controller determines an amount of additional drive current to be provided to the light emitting diode based on the accumulated time that the light emitting diode has been lit and when the light emitting diode is lit, causes the determined amount of additional drive current to be provided to the light emitting diode.

In as aspect, the system generates the determined additional drive current and outputs the determined additional drive current to an anode of the light emitting diode.

In aspect, the system in outputting the determined additional drive current outputs a pulse width modulated signal and the controller adjusts the duty cycle of the pulse width modulated signal to provide the determined additional drive current.

In an aspect, the controller provides a feedback signal indicative of the determined amount of additional drive current at a feedback output.

In an aspect, the controller determines the amount of additional drive current based on a predictive model of degradation of the light emitting diode over time as well as the accumulated time that the light emitting diode has been lit.

In an aspect, an optocoupler system has an optocoupler and a controller. The optocoupler has a phototransistor and a plurality of light emitting diodes. The controller drives the light emitting diodes sequentially with each light emitting diode being driven until it degrades to a certain point and a next one of the light emitting diode is then driven. After each of the plurality of light emitting diodes have degraded to a certain point, the controller drives the plurality of light emitting diodes in parallel.

In an aspect, the controller determines an amount that each light emitting diode has degraded based upon an accumulated amount of time that the light emitting diode has been lit.

In an aspect, the controller determines the amount that each light emitting diode has degraded based upon a predictive model of degradation of that light emitting diode as well as the accumulated time that the light emitting diode has been lit.

In an aspect, the controller determines an additional amount of drive current to be provided to each light emitting diode based upon the amount that each light emitting diode has degraded and causing the determined additional amount of drive current for each light emitting diode to be provided to that light emitting diode when that light emitting diode is lit.

In an aspect, the system generates the determined additional drive currents and outputs the determined additional drive current to anodes of the light emitting diodes.

In an aspect, the system in outputting the determined additional drive currents outputs pulse width modulated signals and the controller adjusts the duty cycle of the pulse width modulated signals to provide the determined additional drive currents.

In an aspect, the system provides feedback signals indicative of the determined amount of additional drive currents at a feedback output.

In an aspect, a method of compensating for degradation of a light emitting diode of an optocoupler includes accumulating time that the light emitting diode has been lit, determining an amount of additional drive current to provide to the light emitting diode based on the accumulated amount of time that the light emitting diode has been lit, and providing the determined amount of additional drive current to the light emitting diode when the light emitting diode is lit.

In an aspect, the method includes determining the amount of additional drive current based on a predictive model of degradation of the light emitting diode over time as well as the accumulated time that the light emitting diode has been lit.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified schematic of a prior art optocoupler;

FIG. 2 is a simplified schematic of a system for compensating for degradation of a light emitting diode of an optocoupler in accordance with an aspect of the present disclosure;

FIG. 3 is a simplified schematic of a monitoring system of the system of FIG. 2;

FIG. 4 is a simplified schematic of the system of FIG. 2 in which the optocoupler and monitoring system are integrated together;

FIG. 5 is a variation of the system of FIG. 4;

FIG. 6 is a graph showing brightness degradation vs. forward current and time of a LED; and

FIG. 7 is a flow chart of a program executed by the monitoring system of FIGS. 3.

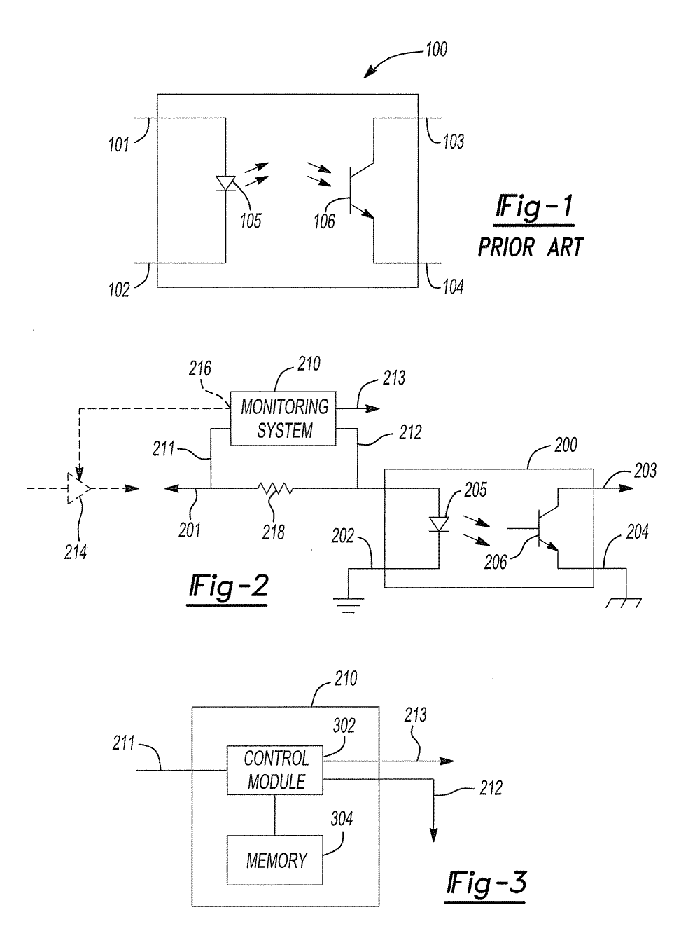

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

In accordance with an illustrative aspect of the disclosure, a system monitors the total amount of time that the LED of an optocoupler has been lit. Based on the total amount of time that the LED has been lit and information about the degradation over time of the LED, the system determines an amount by which the drive current used to drive the LED should be increased to compensate for the degradation of the LED to provide a constant propagation delay as the LED ages.

Referring now to FIG. 2, an illustrative embodiment of the disclosure is now described. An optocoupler 200 includes LED 205 and phototransistor 206. An input terminal 201 of optocoupler 200 is coupled to an anode of LED 205. A terminal 202 of the optocoupler 200, which is coupled to the cathode of the LED 205, is coupled to common. An output terminal 203 of optocoupler 200 is coupled to an output of phototransistor 206, such as by way of example and not of limitation, to the collector of phototransistor 206. Another terminal 204 of the optocoupler 200 is illustratively coupled to the emitter of the phototransistor 206, and may be coupled to common or to another terminal of a destination system (not shown).

A monitoring system 210 monitors optocoupler 200 to keep track of the accumulated time that LED 205 has been lit. Illustratively, monitoring system 210 is coupled to any part of the system having optocoupler 200 from which it can be determined that LED 205 is turned on. For example, monitoring system 210 can be coupled to any or all of input terminal 201 of optocoupler 200, output terminal 203 of optocoupler 200, or a part of an upstream system upstream of input terminal 201 that provides the drive signal to input terminal 201 of optocoupler 200, shown representatively by element 214.

Monitoring system 210 determines whether and how much additional drive current should be added to drive LED 205 when LED 205 is lit. In an aspect, it does so based on the accumulated time that LED 205 has been lit and a predictive model of the degradation of LED 205 over time. In this way, the monitoring system 210 can monitor the input or drive current to the optocoupler 200 and adjust the drive current according to need. In an aspect, the predictive model is a degradation curve of LED 205 obtained from a manufacturer of LED 205 or determined heuristically. In an aspect, the predictive model is a degradation function in the form of an equation, that may be determined heuristically.

In the illustrative embodiment of FIG. 2, an input 211 of the monitoring system 210 is coupled to input terminal 201 of the optocoupler 200 and an output 212 of monitoring system 210 is coupled to the anode of LED 205. In an aspect, a resistor 218 is coupled between the input terminal 201 of the optocoupler 200 and the anode of LED 205 and across input 211 and output 212 of monitoring system 210. It should be understood that resistor 218 could be external to optocoupler 200. Alternatively, the input terminal 201 of optocoupler 200 is coupled through monitoring system 210 to the anode of LED 205 and monitoring system 210 includes a resistor disposed therebetween. Monitoring system 210 determines the compensation for LED 205, which illustratively is how much additional drive current to add to the drive signal driving LED 205 and provides that additional drive current at output 212. The monitoring system 210 may illustratively have another output 213 that provides a drive compensation status of the monitoring system 210. Generally speaking, the drive compensation status could be an On/Off signal indicating that a limit has been reached (e.g., 80% of the compensation range has been reached), or could be a unit of measure indicating the compensation value. In the latter case, the output 212 could be a serial data output on which the compensation value is transmitted. For example, drive compensation status can be the amount by which the drive current to LED 205 has been increased.

In an aspect, output 212 of monitoring system 210 may be a pulse width modulated output and monitoring system 210 sets the duty cycle of the pulse width modulated output to provide the desired amount of additional drive current.

As discussed, monitoring system 210 may itself provide the additional drive current to input terminal 201 of optocoupler 200. Alternatively, as shown by the dashed lines in FIG. 2, monitoring system 210 can provide a feedback signal at a feedback output 216 to upstream system 214 generating the drive signal for LED 205 and that upstream system 214 then increases the drive current of the drive signal based on the feedback signal provided by monitoring system 210 so that the drive signal includes the determined additional drive current. “Feedback signal” as that term is used herein can mean an analog signal, a digital signal, and/or data.

The monitoring system 210 can employ a computational mechanism to determine the compensation. The compensation can be alternatively determined based on statistical analysis. Further, the aforementioned computational mechanism and statistical analysis can be integrated in a functional module.

In an aspect, the monitoring system 210 can employ a predictive model to determine the compensation for the degradation of the LED 205. The predictive model may illustratively be a predictive model of the Current Transfer Ratio (CTR) degradation in the optocoupler. CTR is the ratio between a current change is the output transistor of the optocoupler and the current change in the LED of the optocoupler. This predictive model is dependent on the specific LED used in the optocoupler. It may illustratively be provided by the manufacturer of the optocoupler, or of the LED used in the optocoupler, or may be determined heuristically. FIG. 6 is an example of a degradation curve for the LED of a Fairchild AN-3001 optocoupler (and is FIG. 6 from Application Note AN-3001 published by Fairchild Semiconductor). The predictive models may also be determined as described in W. J. Stapor and P. T. McDonald, “Simple and Practical Optocoupler CTR Degradation Predictive Model,” or as described in T. F. Miyahira and A. H. Johnston, “Trends in Optocoupler Radiation Degradation.”

Referring to FIG. 3, an illustrative example of monitoring system 210 is now described. Monitoring system 210 has a control module 302. Control module 302 may be a processor (shared, dedicated, or group) and memory, such as a microcontroller, that execute one or more software or firmware programs, an Application Specific Integrated Circuit (ASIC), an electronic circuit, a combinational logic circuit, a field programmable gate array, and/or other suitable components that provide the described functionality. Monitoring system 210 also includes a persistent memory 304, which may be nonvolatile memory. Memory 304 may be a separate module or it may be part of control module 302. Control module 302 monitors optocoupler 200 and accumulates the time that LED 205 has been lit and stores this time in persistent memory 304. Based on the accumulated time that LED 205 has been lit and information about the degradation of LED 205 over time, which is illustratively stored in persistent memory 304, control module 302 determines the compensation for optocoupler 200, which is the amount by which the drive current to LED 205 should be increased when LED 205 is turned on to maintain a constant propagation delay.

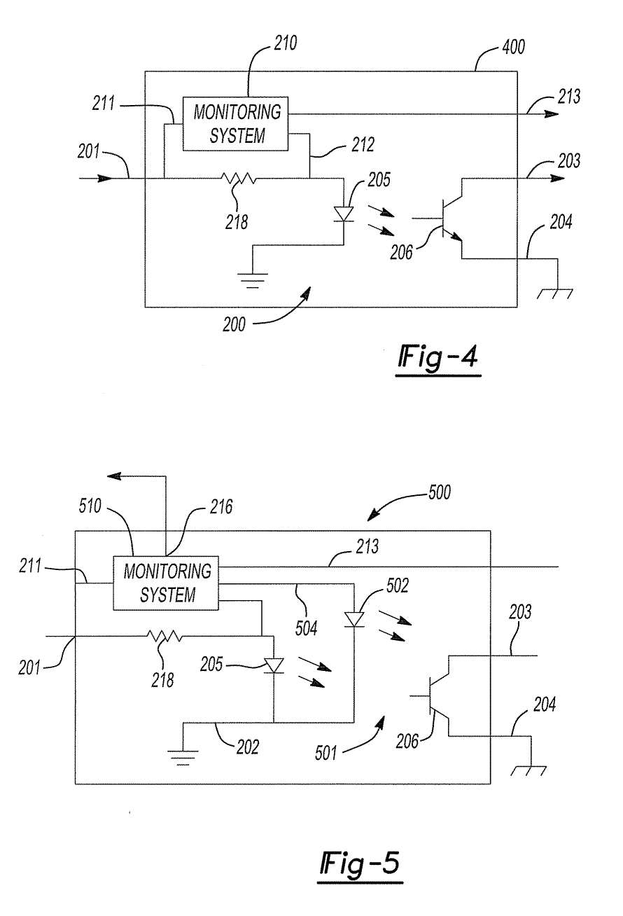

The monitoring system 210 and the optocoupler 200 can be coupled in any fashion. For example, the monitoring system and the optocoupler can be integrated together as shown in FIG. 4, such as in an integrated circuit 400. Alternatively, monitoring system 210 and optocoupler 200 may be separate modules.

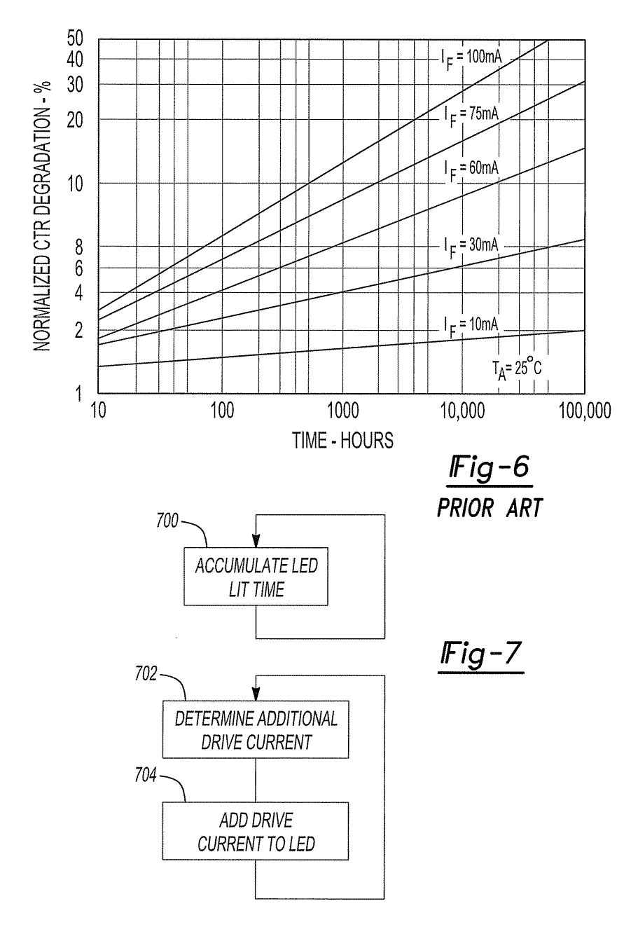

FIG. 7 is a flow chart of an illustrative program executed by monitoring system 210 to compensate for degradation over time of LED 205 of optocoupler 200. At 700, monitoring system 210 accumulates the time that LED 205 has been lit which is stored in memory, such as persistent memory 304. At 702, monitoring system determines the amount of additional drive current to be provided to LED 205 when LED 205 is lit. It does so based on the accumulated time that LED 205 has been lit. In an aspect, it does so based on the accumulated time that LED 205 has been lit and a predictive model of the degradation of LED 205 over time. As discussed above, in an aspect, the predictive model is a degradation curve of LED 205 obtained from a manufacturer of LED 205 or determined heuristically. Also as discussed above, in an aspect, the predictive model is a degradation function in the form of an equation, that may be determined heuristically. The predictive model is stored (such as in the case of a degradation curve) or programmed (such as in the case of an equation) in memory used by controller 302, such as persistent memory 304. In a simple aspect, monitoring system 210 adds an incremental amount of drive current for each incremental amount of time that LED 205 has been lit.

At 704, monitoring system 210 adds the determined additional drive current to the drive current driving LED 205 of optocoupler 200.

With reference to FIG. 5, a variation of the embodiment of FIG. 4 in which the monitoring system 210 and optocoupler 200 are integrated in a single module is described. In the embodiment of FIG. 5, an optocoupler system 500 includes optocoupler 501 having a second LED 502 driven by monitoring system 510 via output 504. Illustratively, LED's 205 and 502 are first driven sequentially and then in parallel. That is, after LED 205 has degraded to a certain point, LED 502 is driven instead of LED 205. After LED 502 has degraded to a certain point, both LED 205 and LED 502 are driven in parallel to provide additional useful life. In an aspect, monitoring system 510 also increases the drive current of the signal driving LED 502 to compensate for degradation of LED 502 over time, in a like manner to that described above with respect to increasing the drive current for LED 205 to compensate for the degradation of LED 205 over time. The provision of second LED 502 prolongs the life of optocoupler 501 compared with optocoupler 200.

Those skilled in the art can now appreciate from the foregoing description that the broad teachings of the disclosure can be implemented in a variety of forms. The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A system for compensating for degradation of a light emitting diode of an optocoupler, comprising:
a controller that accumulates time that the light emitting diode has been lit; and
the controller determining an amount of additional drive current to be provided to the light emitting diode based on the accumulated time that the light emitting diode has been lit and causing the determined amount of additional drive current to be provided to the light emitting diode when the light emitting diode is lit.

2. The system of claim 1 wherein the system generates the determined additional drive current and outputs the determined additional drive current to an anode of the light emitting diode.

3. The system of claim 2 wherein the system in outputting the determined additional drive current outputs a pulse width modulated signal and the controller adjusts the duty cycle of the pulse width modulated signal to provide the determined additional drive current.

4. The system of claim 1 wherein the system provides a feedback signal indicative of the determined amount of additional drive current at a feedback output.

5. The system of claim 1 wherein the controller determines the amount of additional drive current based on a predictive model of degradation of the light emitting diode over time as well as the accumulated time that the light emitting diode has been lit.

6. An optocoupler system, comprising
an optocoupler having a phototransistor and a plurality of light emitting diodes; and
a controller that drives the light emitting diodes sequentially with each light emitting diode being driven until it degrades to a certain point and a next one of the light emitting diode then being driven, and after each of the plurality of light emitting diodes have degraded to a certain point, the controller driving the plurality of light emitting diodes in parallel.

7. The apparatus of claim 6 wherein the controller determines an amount that each light emitting diode has degraded based upon an accumulated amount of time that the light emitting diode has been lit.

8. The apparatus of claim 7 wherein the controller determines the amount that each light emitting diode has degraded based upon a predictive model of degradation of that light emitting diode as well as the accumulated time that the light emitting diode has been lit.

9. The apparatus of claim 7 wherein the controller determines an additional amount of drive current to be provided to each light emitting diode based upon the amount that each light emitting diode has degraded and causing the determined additional amount of drive current for each light emitting diode to be provided to that light emitting diode when that light emitting diode is lit.

10. The system of claim 9 wherein the system generates the determined additional drive currents and outputs the determined additional drive current to anodes of the light emitting diodes.

11. The system of claim 10 wherein the system in outputting the determined additional drive currents outputs pulse width modulate signals and the controller adjusts the duty cycle of the pulse width modulated signals to provide the determined additional drive currents.

12. The system of claim 9 wherein the system provides feedback signals indicative of the determined amount of additional drive currents at least one feedback output.

13. A method of compensating for degradation of a light emitting diode of an optocoupler, comprising:
accumulating time that the light emitting diode has been lit;
determining an amount of additional drive current to provide to the light emitting diode based on the accumulated amount of time that the light emitting diode has been lit; and
providing the determined amount of additional drive current to the light emitting diode when the light emitting diode is lit.

14. The method claim 13 including determining the amount of additional drive current based on a predictive model of degradation of the light emitting diode over time as well as the accumulated time that the light emitting diode has been lit.
